(19) United States
(12) Patent Application Publication
(10) Pub. No.: US 2013/0339132 A1
(43) Pub. Date: Dec. 19, 2013

(54) Single-Source Data Analysis of Advertising and Promotion Effects

(71) Applicants: Michael von Gonten, Delray Beach, FL (US); David Hoo, Ridgewood, NJ (US)

(72) Inventors: Michael von Gonten, Delray Beach, FL (US); David Hoo, Ridgewood, NJ (US)

(73) Assignee: XRAY MARKETING EFFECTIVENESS CONSULTANTS, INC., Delray Beach, FL (US)

(21) Appl. No.: 13/906,226

(22) Filed: May 30, 2013

Related U.S. Application Data
(60) Provisional application No. 61/689,185, filed on May 30, 2012.

(51) Int. Cl. G06Q 30/02

(52) U.S. Cl. CPC G06Q 30/0246
USPC 705/14.45

(57) ABSTRACT

A system constructed using one or more of the techniques described includes a collective set of data structures, information tools, and computational and machine methods useful to store, append, interact with, retrieve, process, and present data and information in a fashion that enables associations to be made between the entities and longitudinal purchase data to ascertain the effectiveness of advertising, promotions, or both.

### CROSS-REFERENCE TO RELATED APPLICATIONS

This application claims priority to U.S. Provisional Patent Application No. 61/689,185, entitled SINGLE-SOURCE DATA ANALYSIS OF ADVERTISING AND PROMOTION EFFECTS, filed May 30, 2012, which is incorporated herein by reference.

### BACKGROUND

Single-source data (SSD) has been thought of as the Holy Grail of advertising research because it provides a measure of exposure to advertising and consumer behavior information on the same identifiable households or individuals is collected over time. SSD includes longitudinal consumer behavior data in response to marketing and advertising exposure. Data is longitudinal in that one or more variables, forming the basis of the data, are observed and/or recorded more than once over a period of time. In a specific case SSD can include television viewing data (as well as other media exposure) matched to a specific entity in response to specific marketing and advertising exposure.

While the concept of SSD exists, no one has been able to take full advantage of SSD and use it in developing marketing and advertising strategies and plans. For example, problematic analytical approaches are typically utilized to analyze SSD. The most common analytical approach has been to compare total sales across groups, aggregated over time. However, this analytical approach does not take into account advertising and marketing effects on penetration and repeat purchases. Furthermore, this analytical approach does not include the effects on SSD among weekly incremental penetration purchases with last split between single between exposed and unexposed single-source measurements. Additionally, due to the massive amount of SSD generated for the same identifiable household or individuals, manipulation and analysis of the massive amounts of SSD is difficult to perform in an organized or efficient manner in order to develop marketing and advertising strategies and plans.

The foregoing examples of the related art and limitations related therewith are intended to be illustrative and not exclusive. Other limitations of the relevant art will become apparent to those of skill in the art upon a reading of the specification and a study of the drawings.

### SUMMARY

The following implementations and aspects thereof are described and illustrated in conjunction with systems, tools, and methods that are meant to be exemplary and illustrative, not necessarily limiting in scope. In various embodiments, one or more of the above-described problems have been addressed, while other embodiments are directed to other improvements.

Various implementations include systems for determining the effectiveness of advertising on an entity from longitudinal single-source data. The effectiveness of advertising can be represented as advertising effectiveness data by various systems and engines described in this paper. In generating the advertising effectiveness data, the various systems and engines can obtain longitudinal single-source data over a time interval for a product or a number of products. The longitudinal single-source data can be separated into incremental penetration and repeat purchase occasions during the time interval. The incremental penetration and repeat purchase occasions can be analyzed along with incremental marketing activities associated with or used to create the longitudinal single-source data. The advertising effectiveness data can be generated from the analysis of the incremental penetration and repeat purchases data and the analysis of the incremental market activities.

These and other advantages will become apparent to those skilled in the relevant art upon a reading of the following descriptions and a study of the several examples of the drawings.

### BRIEF DESCRIPTION OF THE DRAWINGS

FIG. 1 depicts a diagram of an example of a system for determining advertising and promotion effects.

FIG. 2 depicts a graph of a baseline estimate from which measurements of advertising effects on sales or penetration purposes can be generated.

FIG. 3 depicts a table of a baseline from which advertising effect on penetration purchases can be measured and an ad effect line over the baseline.

FIG. 4 depicts a flowchart of an example of a method for SSD analysis and reporting.

FIG. 5 depicts a flowchart of an example of a granular, sequential method for SSD analysis.

FIG. 6 depicts a diagram of an example of an advertising diagnostics platform.

FIG. 7 depicts a conceptual diagram of an example of an SSD analysis flow.

### DETAILED DESCRIPTION

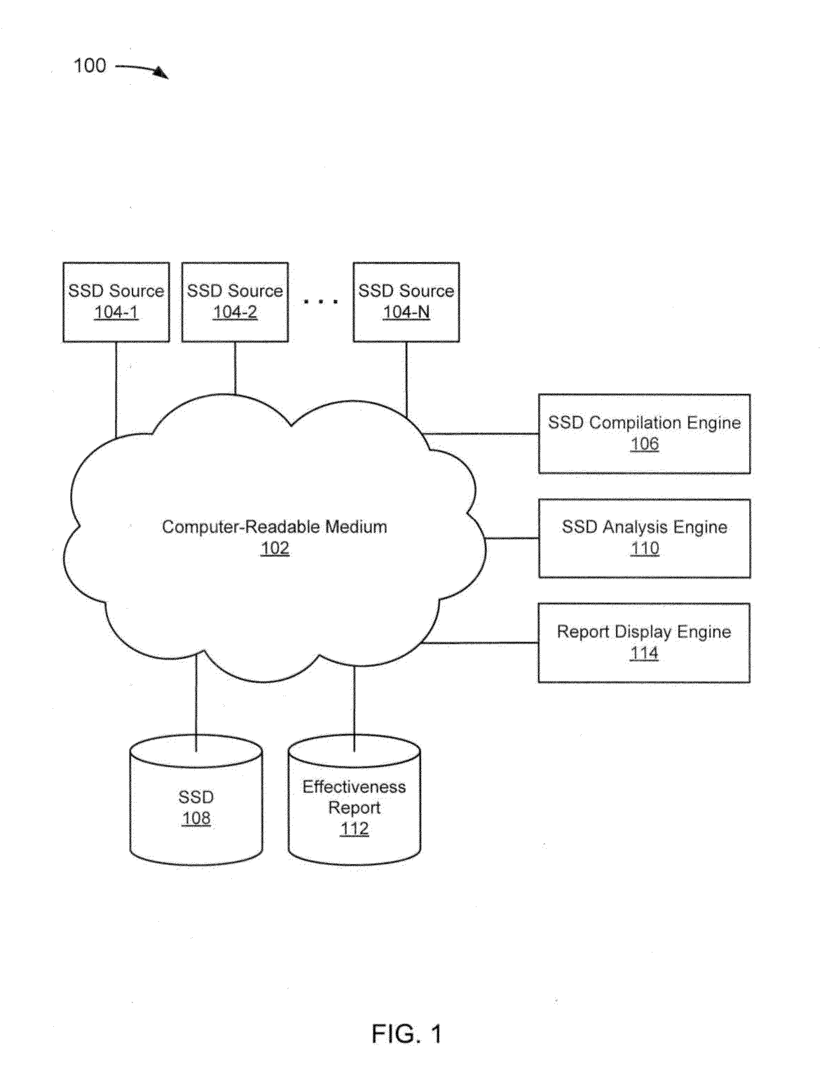

FIG. 1 depicts a diagram 100 of an example of a system for determining advertising and promotion effects. In the example of FIG. 1, the system 100 includes a computer-readable medium 102, single-source data (SSD) sources 104-1 to 104-N (collectively, SSD sources 104), an SSD compilation engine 106, an SSD datastore 108, an SSD analysis engine 110, an effectiveness report datastore 112, and a report display engine 114.

In the example of FIG. 1, the computer-readable medium 102 can include communications hardware within a single computer, a device locally attached to a computer, or a networked system that includes several computer systems coupled together, such as a local area network (LAN), campus area network (CAN), municipal area network (MAN), or wide area network (WAN), but could include any applicable type of network, such as a personal area network (PAN).

A computer system, as used in this paper, includes at least a processor and memory, and can include a device (e.g., a bus) coupling the memory to the processor and other components, such as non-volatile storage, an interface, or the like. The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. As used in this paper, the term “computer-readable storage medium” is intended to include only physical media, such as memory. As used in this paper, a computer-readable medium is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The bus can also couple the processor to the non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, the computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. Interfaces enable computer systems and other devices to be coupled together in a network.

Networks can include enterprise private networks and virtual private networks (collectively, private networks). As the name suggests, private networks are under the control of an entity rather than being open to the public. Where context dictates a single entity would control a network, it should be understood that reference to a network is a reference to the private portion subset of that network. For example, a LAN can be on a WAN, but only the LAN under the control of an entity; so if an engine controls policy on the network, it may be that the engine only controls policy on the LAN (or some other subset of the WAN). Private networks include a head office and optional regional offices (collectively, offices). Many offices enable remote users to connect to the private network offices via some other network, such as the Internet.

The term “Internet” as used herein refers to a network of networks that uses certain protocols, such as the TCP/IP protocol, and possibly other protocols such as the hypertext transfer protocol (HTTP) for hypertext markup language (HTML) documents that make up the World Wide Web (the web). Content is often provided by content servers, which are referred to as being “on” the Internet. A web server, which is one type of content server, is typically at least one computer system which operates as a server computer system and is configured to operate with the protocols of the World Wide Web and is coupled to the Internet. The physical connections of the Internet and the protocols and communication procedures of the Internet and the web are well known to those of skill in the relevant art.

For illustrative purposes, it is assumed the computer-readable medium 102 broadly includes, as understood from relevant context, anything from a minimalist coupling of the components, or a subset of the components, illustrated in the example of FIG. 1, to every component of the Internet and networks coupled to the Internet. In the example of FIG. 1, the computer-readable medium 102 can include a data path, such as a bus, in a computer. In such an implementation, one or more of the components illustrated in the example of FIG. 1 can be implemented on the same machine.

In the example of FIG. 1, the SSD sources 104 are coupled to the computer-readable medium 102. The SSD sources 104 can be implemented on a computer system, a device connected to (or a part of) a computer system, or some other device. The SSD sources 104 may or may not be the same type of device (e.g., the SSD source 104-1 might be a device on the Internet and the SSD source 104-2 might be a flash memory device).

Functionality of the SSD sources 104 can be carried out by one or more engines. As used in this paper, an engine includes at least two components: 1) a dedicated or shared processor and 2) hardware, firmware, and/or software modules that are executed by the processor. Depending upon implementation-specific or other considerations, an engine can be centralized or its functionality distributed. An engine can include special purpose hardware, firmware, or software embodied in a computer-readable medium for execution by the processor. The processor transforms data into new data using implemented data structures and methods, such as is described with reference to the following figures.

The SSD sources 104 function to generate SSD for one or a plurality of entities. SSD includes the effects on an entity in response to not being exposed to marketing or advertising. SSD also includes the effects on an entity in response to exposure to marketing or advertising. For the purposes of this paper, an exposed entity is an entity that is exposed to marketing or advertising, while an unexposed entity is an entity that is not exposed to marketing or advertising. An entity is not limited in size and can include, for example, a single person or a household. The effects on an entity can include the behaviors of an entity in response to exposure to marketing or advertising. The behaviors of an entity can include purchasing, viewing, interacting, communicating, commenting, down-loading, sharing/forwarding, donating, using, gambling or bidding. Specific examples of entity behaviors are loyalty card membership purchasing, renting or usage, charitable giving, making a political contribution, issuing of a frequency gambler card, acquisition of a credit/debit card, ordering products or services over the telephone, purchasing prescription drugs and devices with health insurance, purchasing a cellular phone subscription, purchasing a wholesale club membership, registering in a social media system or network, participating in an auction, downloading or sharing of data through a social media system or network, registering or visiting a website, registering or making an e-commerce purchase or donation, viewing a television or other media display, viewing or bidding in an auction, or blogging or commenting on a website. The marketing or advertising to which the entities are exposed to in forming part of the SSD can include online website display advertising, email advertising, page display advertising, podcast advertising, newsletter advertising, social media advertising, RSS and widget feed advertising, text message advertising, mobile device advertising, radio advertising or television advertising.

In the example of FIG. 1, the SSD compilation engine 106 is coupled to the computer-readable medium 102. The SSD compilation engine 106 can be implemented on one or more computer systems. The SSD compilation engine 106 can function to receive SSD, including longitudinal SSD, from the SSD sources 104 and transform the received SSD into data structures appropriate for storage in the SSD datastore 108. Specifically, the SSD compilation engine 106 can function to transform the received SSD into data structures described in conjunction with the SSD datastore 108 or any other datastore described in this paper. Additionally, the SSD compilation engine 106 can function to transform the SSD into a data structure that includes tabulating the purchase data of or other effects on an entity. The purchase data of or other effects on an entity can be tabulated according to a specific time period during which the data is collected. Furthermore, the purchase data or other effects on an entity can be tabulated according to the characteristics of the specific time period during which the data is collected. For example, the data can be tabulated according to time periods with no advertising or promotions, time periods with advertising, time periods with trade price promotions, time periods with trade price promotions and advertising, or time periods with consumer free-standing inserts (FSI) coupons.

In the example of FIG. 1, the SSD datastore 108 is coupled to the computer-readable medium 102. The SSD datastore 108 can store data structures, such as those described later with reference to the other figures. The SSD datastore 108, or other datastore described in this paper, can be implemented, for example, as software embodied in a physical computer-readable medium on a general- or specific-purpose machine, in firmware, in hardware, in a combination thereof, or in any applicable known or convenient device or system. This and other repositories described in this paper are intended, if applicable, to include any organization of data, including tables, comma-separated values (CSV) files, traditional databases (e.g., SQL), big data datastores (e.g., NOSQL), or other known or convenient organizational formats.

In an example of a system where the SSD datastore 108, or other datastore described in this paper, is implemented as a database, a database management system (DBMS) can be used to manage the SSD datastore 108. In such a case, the DBMS may be thought of as part of the SSD datastore 108 or as part of the SSD compilation engine 106, or as a separate functional unit (not shown). A DBMS is typically implemented as an engine that controls organization, storage, management, and retrieval of data in a database. DBMSs frequently provide the ability to query, backup and replicate, enforce rules, provide security, do computation, perform change and access logging, and automate optimization. Examples of DBMSs include Alpha Five, DataEase, Oracle database, IBM DB2, Adaptive Server Enterprise, FileMaker, Firebird, Ingres, Informix, Mark Logic, Microsoft Access, InterSystems Cache, Microsoft SQL Server, Microsoft Visual FoxPro, MonetDB, MySQL, PostgreSQL, Progress, SQLite, Teradata, CSQL, OpenLink Virtuoso, Daffodil DB, and OpenOffice.org Base, to name several.

Database servers can store databases, as well as the DBMS and related engines. Any of the repositories described in this paper could presumably be implemented as database servers. It should be noted that there are two logical views of data in a database, the logical (external) view and the physical (internal) view. In this paper, the logical view is generally assumed to be data found in a report, while the physical view is the data stored in a physical storage medium and available to, typically, a specifically programmed processor. With most DBMS implementations, there is one physical view and a huge number of logical views for the same data.

A DBMS typically includes a modeling language, data structure, database query language, and transaction mechanism. The modeling language is used to define the schema of each database in the DBMS, according to the database model, which may include a hierarchical model, network model, relational model, object model, or some other applicable known or convenient organization. An optimal structure may vary depending upon application requirements (e.g., speed, reliability, maintainability, scalability, and cost). One of the more common models in use today is the ad hoc model embedded in SQL. Data structures can include fields, records, files, objects, and any other applicable known or convenient structures for storing data. A database query language can enable users to query databases, and can include report writers and security mechanisms to prevent unauthorized access. A database transaction mechanism ideally ensures data integrity, even during concurrent user accesses, with fault tolerance. DBMSs can also include a metadata repository; metadata is data that describes other data.

In the example of FIG. 1, the SSD analysis engine 110 is coupled to the computer-readable medium 102. The SSD analysis engine 110 can be implemented as one or more computer systems. The SSD analysis engine 110 can function to generate advertising effectiveness data from the data stored in the SSD datastore 108, that includes or is part of the SSD data received from the SSD sources 104, that are appropriate for storage in the effectiveness report datastore 112. The advertising effectiveness data can include quantitative data that describes or represents the market penetration and/or the overall success of specific advertising or marketing.

In the example of FIG. 1, the effectiveness report datastore 112 is coupled to the computer-readable medium 102. The effectiveness report datastore 112 can have data structures in which the generated advertising effectiveness data can be stored. For example, the effectiveness report datastore 112 can include an advertising effectiveness data structure generated by the SSD analysis engine 110 using incremental penetration and repeat purchase occasions during a time interval and the incremental marketing activities during the time interval. Advantageously, the effectiveness report data structures have been found to be more valid and precise than any advertising effectiveness measure of which the inventors are aware. In other respects, the data structures are intended to have a format that is convenient for displaying the results to a human user interested in understanding the effectiveness of advertising efforts on the entities associated with the SSD in the SSD datastore 108.

The advertising effectiveness data can be measurements of advertising and marketing effects on sales of a product. Specifically, the effects on sales of a product can be rendered, by the SSD analysis engine 110, from the effects on an entity, including behaviors of an entity, after exposure to advertising and marketing. For example, the effects on sales of a product can be rendered from behaviors of an entity, including whether an entity actually purchased a product or looked at a product after being exposed to the advertising or marketing. The measurements of effects on sales of a product can also be rendered from measureable data about the advertising and marketing including overall total advertising effect; advertising campaign: A, B, C, etc.; commercial execution: a, b, c, etc.; commercial Length: :15, :30, >:30, etc.; media weight—reach; media weight—frequency; media schedule—flighted vs. continuous; media channel: network, cable, online, etc.; day part: daytime, news, primetime, etc.; program type: drama, sports, news, etc.; other advertising or promotion effects. This can include applying an algorithm to penetration and repeat purchase behavior.

In functioning to render the SSD from the SSD datastore 108 into advertising effectiveness data, including measurements of advertising and marketing effects on sales, the SSD analysis engine 110 can generate overall and granular advertising and marketing effects on sales. In generating the overall and granular effects on sales, the SSD analysis engine 110 can isolate overall and specific granular effects on sales to one or a plurality of exposed entities over incremental time periods from the SSD stored in the SSD datastore 108. Overall effects on sales can include advertisements ability to increase the penetration or size of an identifiable group. A granular effect on sales, can be an effect on sales for a specific increment of time, an effect on sales for a single advertisement or any number of specific advertisements or an effect on sales within a specific market or demographic. Isolating the overall and granular effects on sales can include isolating instances of an entity repeat buying a product after being exposed to advertisement or marketing. The SSD analysis engine 110 can filter out and remove the instances of repeat buying by one or a plurality of entities in determining the overall and/or granular advertising effects on sales. Alternatively, the SSD analysis engine 110 can determine the overall and granular effects on sales from the isolated instances of repeated buying. The SSD analysis engine 110 can further use the tabulated purchase data or effects on an entity in determining the overall and/or specific advertising effects on sales. The measurements of advertising and marketing effects on sales can be stored, as part of effectiveness report data, in the effectiveness report datastore 112.

Furthermore, in generating advertising effectiveness data, the SSD analysis engine 110 can function to generate a baseline estimate of projected unexposed sales. The baseline estimate of the projected unexposed sales is an estimate of the sales to entities that are not exposed to advertising or marketing. Specifically, the baseline estimate can be a single-source measurement of penetration purchases among entities with “no opportunity for advertising exposure,” during an off-air unpromoted time period. In an off-air unpromoted time period, all entities within a market are unexposed and the opportunity to see or be exposed to the specific advertising or marketing is zero. The baseline estimate of the projected unexposed sales can be determined over any period of time for any number of entities. For example, the baseline estimate of the projected unexposed sales can be determined for entities within a specific market, for example a specific geographical region or age demographic. The baseline estimates generated by the SSD analysis engine 110 can be stored, as part of effectiveness report data, in the effectiveness report datastore 112.

The SSD analysis engine 110 can use the baseline estimate of projected unexposed sales along with other SSD to render a measurement of the advertising and marketing effects on sales of a product. The measurement of the advertising and marketing effects on sales of a product can be part of the advertising effectiveness data. The measurement can be a quantitative value of the effect of marketing or advertising on the sales of a product. Specifically, the SSD analysis engine can generate a quantitative value of the effect of marketing by comparing the baseline estimate of projected unexposed sales with the effects on an entity in being exposed to advertising and marketing. In one example, the generated quantitative value of the advertising and marketing effects on sales of a product is the ratio of the baseline estimate of the projected unexposed sales with the amount of actual sales of a product to entities exposed to advertising or marketing.

The quantitative values of the effect of marketing or advertising on the sales of a product can be represented and/or stored as a graph. For example, the quantitative values or measurements can be graphically displayed for successive periods of time, thereby illustrating changes to the effects of marketing or advertising on the sales of a product over time. Additionally, the quantitative values or measurements of the effect of marketing or advertising on the sales of a product generated by the SSD analysis engine 110 can be stored, as part of effectiveness report data, in the effectiveness report datastore 112.

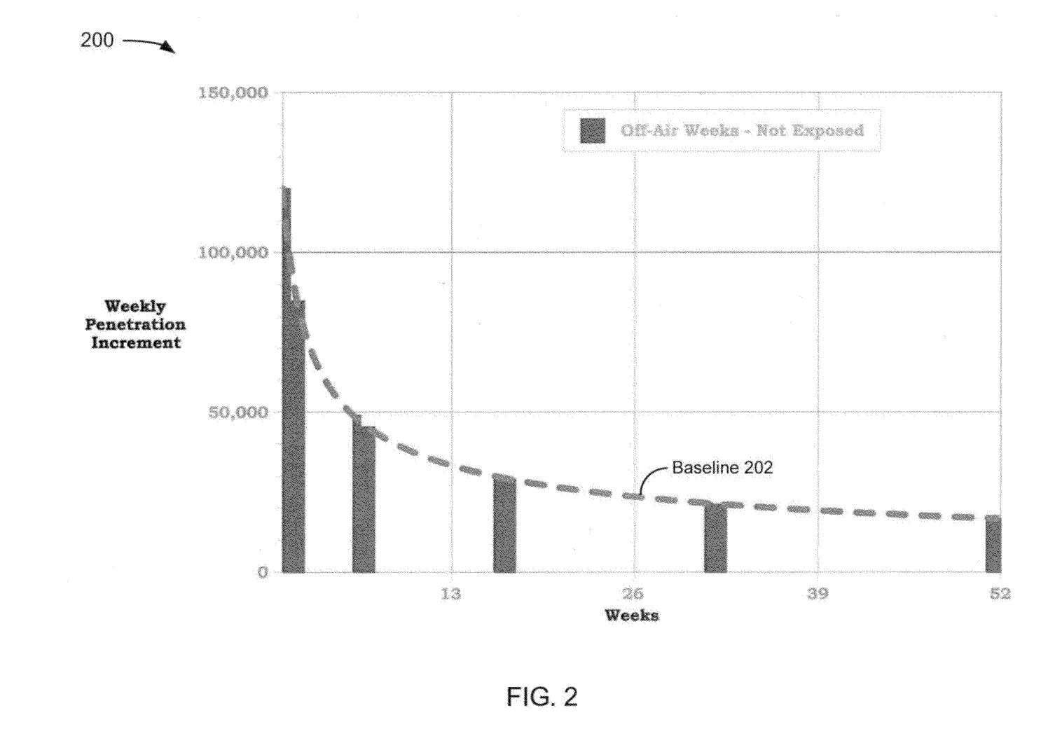

FIG. 2 depicts a graph 200 of a baseline estimate from which measurements of advertising effects on sales or penetration purposes can be generated. The generated advertising effects can be represented as or used to create advertising effectiveness data. The graph is the weekly penetration as a function of weeks. The weekly penetration can represent the amount of sales of one or a plurality of products or a value or measurement that represents any of the previously described advertising or marketing effects on sales of a product. The baseline estimate in FIG. 2 can be created by the various engines or systems described in this paper, including the SSD analysis engine 110 of FIG. 1.

The graph corresponds to a media schedule with forty-two total on-air weeks and five two off-air weeks. As is used in this paper, an “on-air” week is a week during which entities are exposed to advertising or marketing. Additionally, as is used in this paper, an “off-air” week is a week during which entities are not exposed to advertising or marketing. While the media schedule is segmented with time periods of weeks, the media schedule can be segmented according to any time period, such as days. Weeks during which price promotions are offered are not included as part of the media schedule. However it is appreciated that a media schedule can include weeks during which price promotions are offered. Price promotions can be offered during on-air weeks and off-air weeks.

In the example of FIG. 2, purchase behavior for the media schedule is modeled as a media schedule data structure using parameters typical of consumer packaged goods (CPG) brands. The purchase behavior can be reflected as the weekly penetration of a product. The graph in the example of FIG. 2 includes an expected baseline 202. The baseline 202 can literally be interpreted as “here is what would happen to penetration each week if the brand was off-air and unpromoted.” Specifically, the baseline 202 can represent the amount of sales of a product that is not advertised or marketed to consumers. For each week, whether or not the weeks are on-air, the media schedule data structure provides an estimate of off-air unpromoted or unexposed penetration value for that week.

Without actually knowing the schedule or ad weight, the media schedule data structure is predictive of what unexposed entities will do by way of penetration purchases during exposed or on-air unpromoted weeks. This is possible because the model was fitted to the off-air unpromoted weeks that are the functional equivalent of single-source unexposed entities. Expected unexposed penetration, expressed as entity counts for each on-air week, modeled as an expected unexposed penetration data structure using the off-air unpromoted weeks that form the baseline 202, are the household counts that fall under the baseline 202. The baseline 202 can be compared to the weekly penetration increment in order to determine advertising or marketing effects on an entity including the effects on sales of a product.

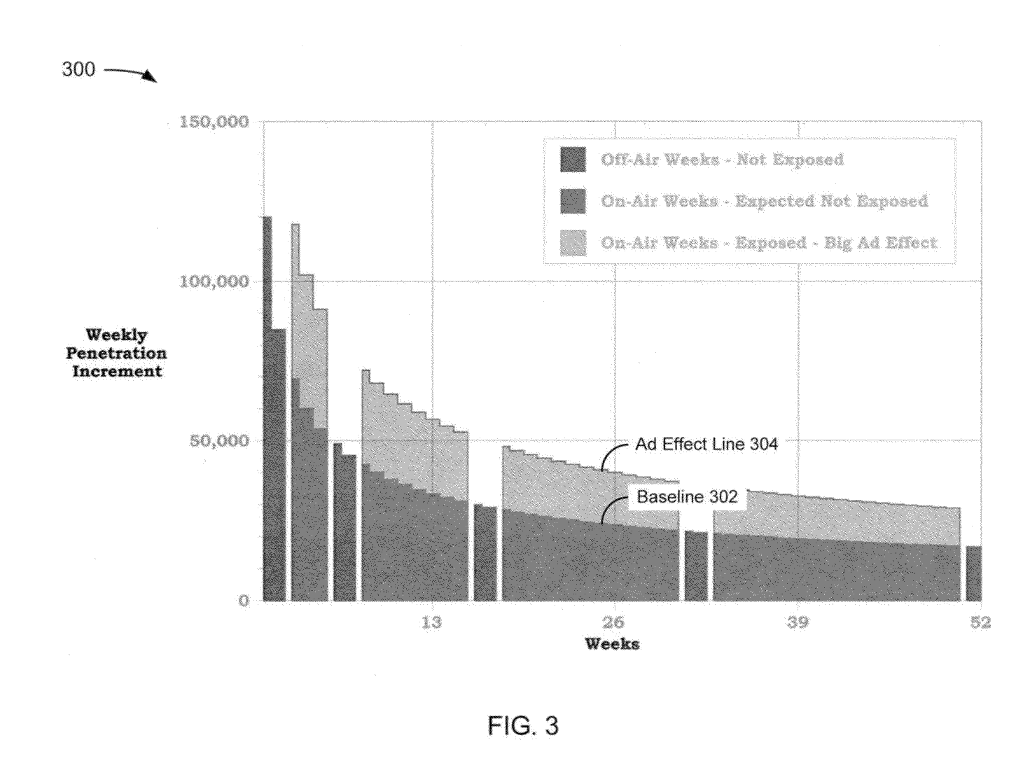

FIG. 3 depicts a table 300 of a baseline from which advertising effect on penetration purchases can be measured and an ad effect line over the baseline. The measured advertising effects can be represented as or used to create advertising effectiveness data. When the actual penetration for on-air weeks is laid on top of the baseline, the SSD analysis engine 110 can provide a direct measure of ad effect. The effect of the advertising exposure over expected off-air or unexposed entity counts is the lift the table 300 illustrates as an ad effect line 304 over the baseline 302. By way of example, FIG. 3 simulates a big ad effect on penetration. The shown effect on penetration is a 70% lift over the baseline 302. To scale the weekly lift to an actual airing schedule, the 70% lift in penetration will become a 70% lift in volume if on-air every week of the year. At 17 weeks on-air, the volume lift becomes about 23%, with about half of that gain seen in the first year and the remainder in the second year as incremental penetration households flow through repeat levels over time.

In the example of FIG. 1, the report display engine 114 is coupled to the computer-readable medium 102. The report display engine 114 can be implemented as one or more computer systems. The report display engine 114 functions to retrieve effectiveness report data from the effectiveness report engine datastore 112 and transform data from the effectiveness report engine datastore 112 into data structures appropriate for display on a suitable device. The report display engine 114 may or may not be considered to include the display device, drivers for the display device, and other known components. The report display engine 114 can also be configured to display preformatted display data structures (perhaps stored in the preformatted state in the effectiveness report datastore 112), insert data into templated display data structures, generate display data structures on the fly for the data, or display relevant contents of the effectiveness report datastore 112 in some other manner (e.g., in an audio stream, a multimedia stream, or a machine-readable format, etc.). An example of reports includes reports about measurement and forecasting with SSD of immediate and longer-term value of advertising in general sales.

Advantageously, the SSD analysis engine 110 builds a surrogate for penetration among the single-source unexposed group. The lift is the ad effect among the exposed group. Thus, the report display engine 114 can report ad effectiveness that is a virtual match for an idealized single-source data analysis. This also means that SSD becomes diagnostic, enabling, for example, a measurement of the number of exposures necessary to produce a desired effect (e.g., perhaps one exposure for a strong commercial or three exposures for a weak commercial). The report display engine 114 can facilitate selecting effective commercials by controlling media variables through single-source exposure measurement. The report display engine 114 can act as a screen for effective commercials so as to more confidently test optimized advertising programs.

While SSD is a powerful diagnostic, the data can get thin for smaller penetration brands. By the time you tabulate penetration entities (e.g., households) by week, segregated by exposed vs. unexposed, further by the number of exposures, or by exposure class (prime, cable, etc.) you rapidly run out of entities for a robust sampling. Thin data makes management teams nervous about scaling up findings to national-level expenditures. One solution for this issue is using SSD as discovery labs. The SSD analysis engine 110 can isolate effective commercials and effective media schedules, exposure counts, etc., using SSD and the implemented models. The report display engine 114 can then provide the best-case schedule and commercials in expanded markets, or regional feed, using, e.g., larger non-single-source Dunnhumby panels to analyze the data.

Advantageously, the system 100 enables replication of single-source exposed-unexposed measures when there is no concurrent consumer or trade promotion, without restrictive single-source requirements, costs, and sample size limitations. Using the same analysis in both the discovery lab phase and larger-scale phase allows quick and robust confirmation at multi-million panel sizes. It also makes it possible to continuously monitor brands, experiment with alternative schedules on-the-fly or track competitors.

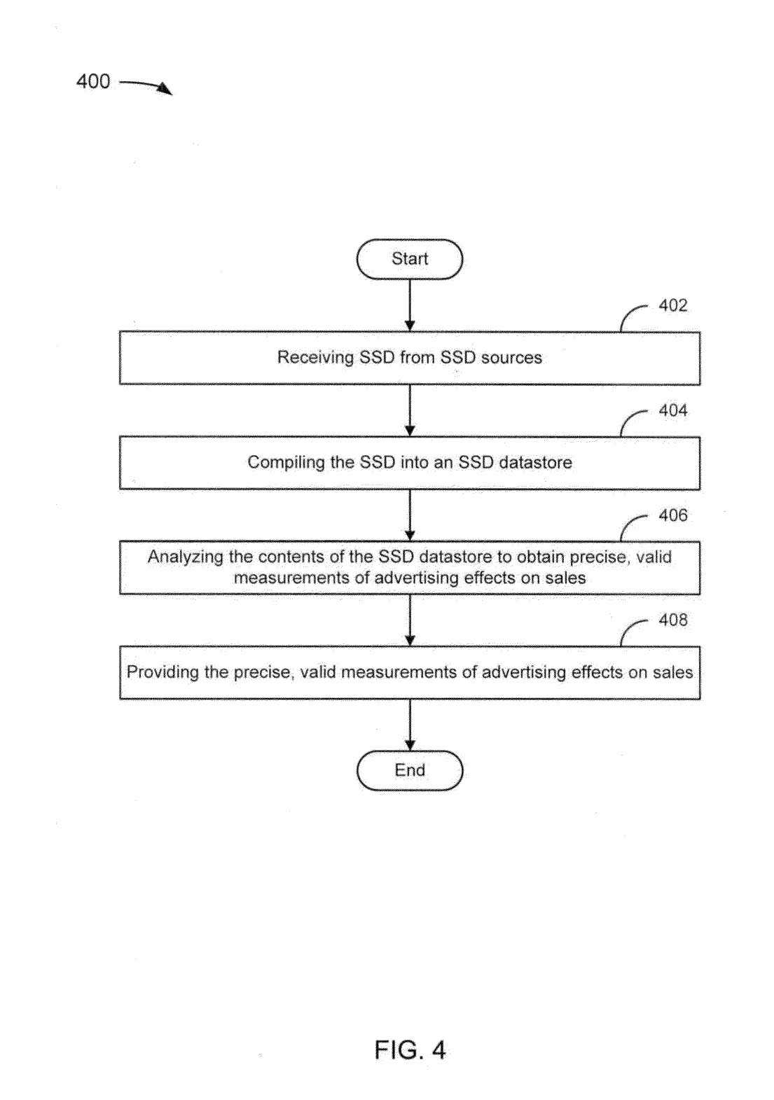

FIG. 4 depicts a flowchart 400 of an example of a method for SSD analysis and reporting. This method and other methods are depicted as serially arranged modules. However, modules of the methods may be reordered, or arranged for parallel execution as appropriate. In the example of FIG. 4, the flowchart 400 starts at module 402 with receiving SSD from SSD sources, such as those described by way of example with reference to FIG. 1.

In the example of FIG. 4, the flowchart 400 continues to module 404 with compiling the SSD into an SSD datastore, such as that described by way of example with reference to FIG. 1. The SSD can include media exposure data, penetration data, and repeat purchase data for identifiable entities.

In the example of FIG. 4, the flowchart 400 continues to module 406 with analyzing the contents of the SSD datastore to obtain precise, valid measurements of advertising effects on sales. The precise and valid measurements of advertising effects can be represented as or used to create advertising effectiveness data. The analysis can include making use of an algorithm implemented as an engine to determine how advertisements or marketing for a product or group of products effectively impacts and increase incrementally, either 1) the penetration or size of an identifiable group of unique exposed entities (individuals or households) for a given behavior or response, or 2) the rate of repeating the behavior or response among the exposed entities within the group. Specifically, at module 406, analyzing the contents of the SSD in the SSD datastore can apply to applicable consumer behavior that involves an initial behavior followed by repeated same or similar behaviors for which these behaviors are tracked and measured from longitudinal data. Behaviors can include but are not limited to: purchasing, viewing, interacting, communicating, commenting, down-loading, sharing/forwarding, donating, using, gambling, bidding, etc. At the same time, advertising and promotion exposures are also tracked and measured longitudinally among the identically same individuals or households (but not necessarily personally identifiable). Other techniques for identifiably tracking can include but are not limited to: computers with cookied Internet browsers, mobile communication devices/telephone traceable to unique telephone numbers, registered users or members of an offline/online group, organization or website.

Examples of potential behavioral applications can include by way of example:
Loyalty card membership and purchasing, renting or usage
Charitable giving to a specific charity
Political contributions to a party, candidate or political interest group
Frequent gambler cards for gambling play at a specific casino
Credit/debit card acquisition and payment usage
Telephone ordering with telephone number as the unique identification
Prescription drug and device purchases with health insurance and subsequent drug or device consumables purchases
Telephone cellular phone subscriptions and usage
Wholesale club membership and club purchasing
Registered or cookied website visits and webpage viewing behavior
Registered or cookied e-commerce purchases or donations
Social media registration and on-going member initiated activities and interactions
Television viewing of specific programs or specific day and time of viewing
Blogging viewing if cookied and commenting and linking interactions
Auction attendance, viewing and bidding
Social media membership and posting, commenting, interacting, downloading and sharing

SSD advertising and promotion exposure can include but is not limited to known or convenient offline, online or recorded (DVR/TIVO) including by way of example:
Online website display advertising, emailings, downloads, page views, photos/videos viewed, podcasts and newsletters
Keyword organic and paid search terms, link click-throughs and associated page views
Social media advertisements, emailings, member postings, friend alerts and comments, page views, click-throughs and associated page views, downloads, photos/videos viewed, podcasts and other interactions
Digital magazine advertising and interactions,
Direct mail, email, RSS and widget feeds
Mobile phone ads, text messages, alerts, GPS locations

As used in this paper, implemented algorithms and other symbolic representations of operations on data bits within a computer memory are concepts understood by those skilled in the data processing arts to effectively convey the substance of work to others skilled in the relevant art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. The signals take on physical form when stored in a computer readable storage medium, such as memory or non-volatile storage, and can therefore, in operation, be referred to as physical quantities. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it should be appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical quantities within the computer system's registers and memories into other data similarly represented as physical quantities within the computer system memories or registers or other such information storage, transmission or display devices.

The algorithms and displays presented herein are not necessarily inherently related to any particular computer or other apparatus. Various general purpose systems may be used with programs to configure the general purpose systems in a specific manner in accordance with the teachings herein, or it may prove convenient to construct specialized apparatus to perform the methods of some embodiments. The required structure for a variety of these systems will appear from the description below. Thus, a general purpose system can be specifically purposed by implementing appropriate programs. In addition, the techniques are not described with reference to any particular programming language, and various embodiments may thus be implemented using a variety of programming languages.

In the example of FIG. 4, the flowchart 400 ends at module 408 with providing the precise, valid measurements of advertising effects on sales. Providing the effects can include displaying the advertising effects on sales or providing data sufficient to display advertising effects on sales elsewhere. The advertising effects on sales can be displayed in any of the example graphical formats shown in FIGS. 2 and 3. Specifically, displaying the advertising effects on sales can include displaying the baseline that can be used to generate the measurements of the advertising effects on sales of a product.

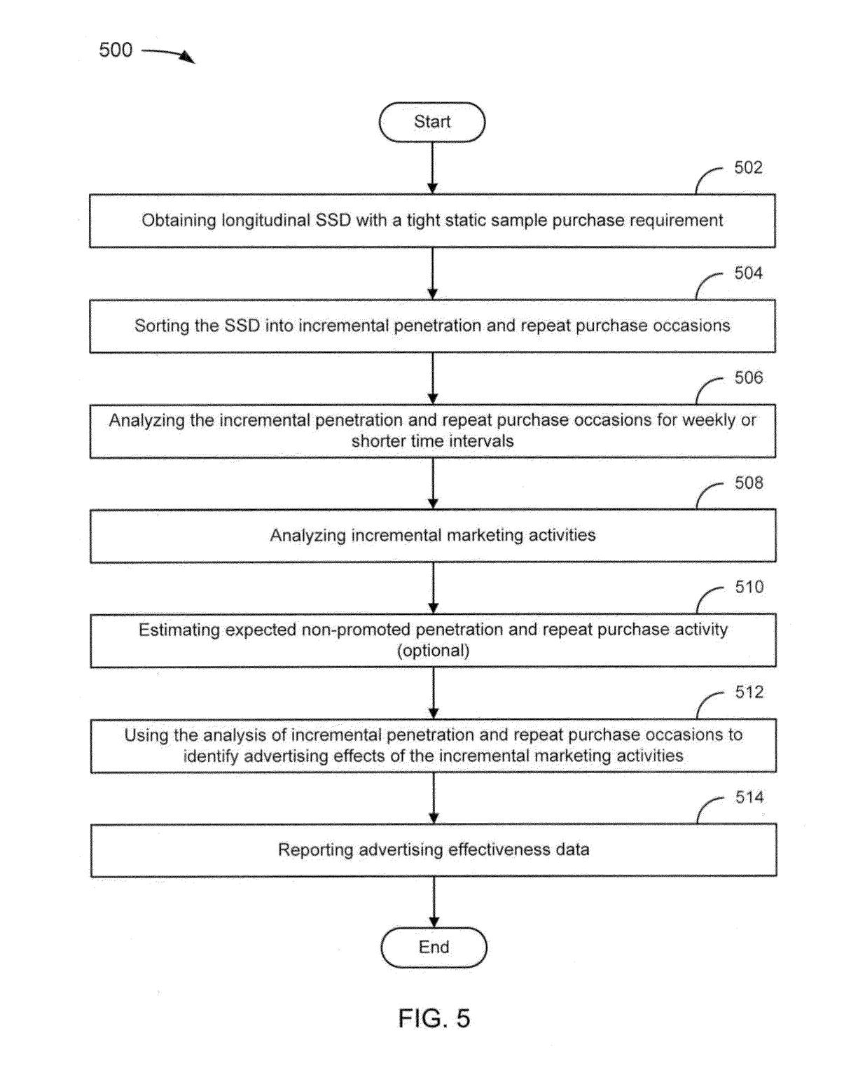

FIG. 5 depicts a flowchart 500 of an example of a granular, sequential method for SSD analysis. In the example of FIG. 5, the flowchart 500 starts at module 502 with obtaining longitudinal SSD with a tight static sample purchase requirement. The SSD is longitudinal to ensure each entity has a complete and uninterrupted purchase history. The SSD has a tight static sample purchase requirement to ensure the time interval matches the level of analysis, such as weeks, days, or hours, from which the advertising effectiveness data is generated. Specifically, the tight static sample purchase requirement can correspond to the amount of time that is necessary to generate accurate and reliable advertising effectiveness data from the longitudinal SSD. The amount of time that is necessary to generate accurate and reliable advertising effectiveness data can be dependent upon a number of factors including, the type of product for which the advertising effectiveness data is being generated, the advertising that is being analyzed, the market of the entities that the longitudinal SSD data corresponds to and the type of entity for which the longitudinal SSD data corresponds. Depending upon the nature of the SSD, the SSD may or may not be suitable for certain time intervals. In a specific implementation, the suitability of the SSD for certain time intervals will be known based upon the nature of the SSD.

In the example of FIG. 5, the flowchart 500 continues to module 504 with sorting the SSD into incremental penetration and repeat purchase occasions. Penetration purchase occasions can be defined as a first (in time) measured purchase of a given product during a time period being analyzed. Repeat purchase occasions can be defined as a set of second (in time) and later measured purchases of the given product during the time period of analysis. Total purchase occasions can be defined as the sum of the penetration and repeat purchase occasions.

Disaggregated penetration, repeat, and total purchases occasions should be on an incremental rather than cumulative basis because measuring at the level of total sales dilutes ad effects by including repeat buying behavior that is unaffected by the advertising. This dilution understates the value of advertising and systematically biases spending mix ROI calculations against advertising. The dilution contributes to understating the immediate effect in the first year and then is further understated as the longer-term effect is only estimated (not measured) by multiplying this immediate effect by an externally derived 2× factor for the second and third years. This 2× factor grossly understates the longer-term value for products purchase 3 to 4 times a year. Further, measuring and modeling at the level of total sales prevents being able to properly model as a data structure the intermediate and longer run consequences of ad effects. A penetration and repeat data structure model, on the other hand, properly “flows” buyers over time, allowing accurate measurement, modeling, and forecasting of longer-run volume gains of advertising at specific points in time. Accurate measurement of the full sales and profit value of advertising, including the advertising induced-penetration and subsequent repeat purchasing persistently at full price and margin, yields accurate true ROI calculations and unbiased spending level or mix allocations.

Contrary to expectations of those skilled in the art of estimating advertising effectiveness, the inventors have determined that advertising almost always impacts penetration, leaving the repeat purchase rate or repeat frequency unaffected by the advertising. This process and finding is radically different from what is the norm for advertising effectiveness analysis and modeling. Those who analyze SSD are simply unaware, unknowledgeable, and unpressured on needing to analyze SSD any way other than the simple most obvious way (to approach advertising effects by measuring at the level of “total aggregate sales”), which does produce an answer—though not at all accurate. The reason for the lack of accuracy is advertising almost never drives repeat buying, which is dominated by product use experience, satisfaction with the brand, and normal purchase frequency. Over longer periods of time, say, 8 to 10 weeks, repeat buying begins to dominate penetration as a percentage of total sales, meaning that any advertising effects on penetration that might be present are diluted by the repeat buying, when measured at the level of total aggregate sales. This dilution means that the true effects of advertising are understated, and ROI calculations are therefore biased against advertising. Isolating the measurement of advertising on penetration or repeat purchases, as opposed to their combined total, increases the measurement sensitivity. Further, all of the methods currently used contain a failure of model architecture that prevents the direct measurement of the longer-term consequences of advertising. Advantageously, disaggregating penetration and repeat purchase occasions enables the production of an accurate answer at least in part because the incremented penetration households flow through the repeat buying levels downstream in time.

In the example of FIG. 5, the flowchart 500 continues to module 506 with analyzing the incremental penetration and repeat purchase occasions for weekly or shorter time intervals. The total time period should be granularly analyzed in at least weekly or shorter (daily, hourly, etc.) time intervals. This granular unit of analysis enables the capture of naturally occurring variations in advertising copy, copy unit, media schedule, media programs, mail or newspaper coupon and refund offers, trade merchandising, and price promotions that also matches well with consumer purchasing patterns. For conventional offline purchasing of frequently purchased CPG, consumers typically shop not necessarily on the same day they are exposed to advertising or promotion but rather on a weekly basis. Accordingly, weekly analysis intervals will more likely capture measurable advertising and promotion effects on sales. Accumulating over periods longer than individual weeks agglomerates specific advertising effects, losing measurement sensitivity and granularity. For online advertising and e-commerce, daily, or even hourly, time intervals for analysis are more appropriate, as a consumer purchase can immediately follow an advertising or promotion exposure.

The sequencing of first disaggregating penetration and repeat purchase behavior and then analyzing in weekly or shorter time intervals is beneficial for perhaps two reasons. First, if penetration and repeat purchases are the criterion value, then this would be the first analytic break in the data within which there should be the search for causal drivers of those purchases. Second, to analytically first break the data on another basis, for instance into the seductive exposed and unexposed, would destroy the longitudinal property of the data within these two groups and prevent determining which purchases are penetration versus repeat. Surprisingly, there is no need to do this because longitudinal SSD enables direct measurement of advertising-driven product sales among the exposed versus the unexposed.

In the example of FIG. 5, the flowchart 500 continues to module 508 with analyzing incremental marketing activities. Assuming measurement among disaggregated penetration in weekly increments when there is no price promotion, the effect of specific advertising is a matter of how much greater sales are than when the advertising is on-air versus modeled and expected sales when advertising is off-air (without any promotion). In this specific example, advertising and promotional activity measurements should be on an incremental basis rather than a cumulative basis during matching time intervals for the separate penetration, repeat, and total purchase occasions. Analyzing the incremental marketing effects on separate incremental penetration and repeat purchase data for each time interval allows each time interval observation to be statistically analyzed as an independent event, providing more robust measurements with greater statistical confidence for differences or trends across the time intervals.

Additional problems associated with analyzing market activities include differences in commercial executions, copy lengths; differences in media reach and frequency, schedule continuity, program selections; differences in concurrent consumer and trade promotion and reducing the measurement of promotion interactions between effects with advertising effects.

In the example of FIG. 5, the flowchart 500 continues to optional module 510 with estimating expected non-promoted penetration and repeat purchase activity. The separate penetration and repeat purchases in each time interval of analysis can be sorted into two or more hierarchical sub-groups, the first split being households or individuals who are through SSD known to have had the opportunity of being exposed to a given advertisement versus those known not to have that opportunity. Subtracting the number of purchases among the non-exposed group from the exposed group is the incremental effect of the advertising on actual sales for each individual time interval. However, because longitudinal penetration or repeat purchase occasions typically occur over time in curvilinear patterns, the ratio of the number of purchases among the exposed to the number of purchases among the non-exposed entities provides a quantitatively comparable measurement across multiple time intervals.

In the example of FIG. 5, the flowchart 500 continues to module 512 with using the analysis of incremental penetration and repeat purchase occasions to identify advertising effects of the incremental marketing activities. The identified advertising effects can be represented as or used to create advertising effectiveness data. The specific effects that can be captured from the original longitudinal SSD can include the advertising or promotion effects listed in Table 1: Advertising or Promotion Effect, below.

TABLE 1
ADVERTISING OR PROMOTION EFFECT

| Advertising or | Among | Among Non- | Exposed to Non- |
|---|---|---|---|
| Promotion Effect | Exposed | Exposed | Exposed Ratio |
| Advertising Campaign: | | | |
| A, B, C, etc. | | | |
| Commercial Execution: | | | |
| a, b, c, etc. | | | |
| Commercial Length: | | | |
| :15, :30, >:30 | | | |
| Media Weight-Reach | | | |
| Media Weight-Frequency | | | |
| Media Schedule: Flighted | | | |
| vs Continuous | | | |
| Media Channel: Network, | | | |
| Cable, Online | | | |
| Day Part: Daytime, News, | | | |
| Primetime | | | |
| Program Type: Drama, | | | |
| Sports, News | | | |
| Commercial POD Position | | | |
| Other Advertising or | | | |
| Promotion Effects | | | |

In the example of FIG. 5, the flowchart 500 ends at module 514 with reporting advertising effectiveness data. The report can include effectiveness of past, current, or (predicted) future advertising activities. At least in part because marketing activities are analyzed incrementally as discrete units, it becomes possible to identify effectiveness of specific marketing activities over relatively short periods of time or more long-term advertising campaign effectiveness. The reported data can take the form of an actual human-readable report, data that can be inserted into a report template, or data from which a report can be generated.

Advantageously, the method illustrated in the example of FIG. 5 can replicate and scale the unpromoted exposed versus unexposed sales measurement by analyzing longitudinal sales data without matching advertising exposure data (non-SSD). The advantage of this replication at scale is that much larger sample sizes are available to confirm with greater statistical confidence the effectiveness of changes in advertising programs that can have major financial implications. Changes in advertising can represent major multi-million dollar marketing expenditures, and more importantly, even greater financial stakes in the expected sales and profit achievement based on these changes. Smaller single-source sample sizes can act as discovery labs that afford keen and valuable advertising insights with all the media viewing diagnostics directly measured among the exposed, but the sub-samples sizes are much too small to reliably measure true sales outcomes when the financial stakes are very high. Longitudinal purchase data from food and drug loyalty card programs could provide sample sizes that are a factor of 10× to 25× larger than currently available SSD. In addition, these larger samples are likely to provide greater geographic and retail channel representations.

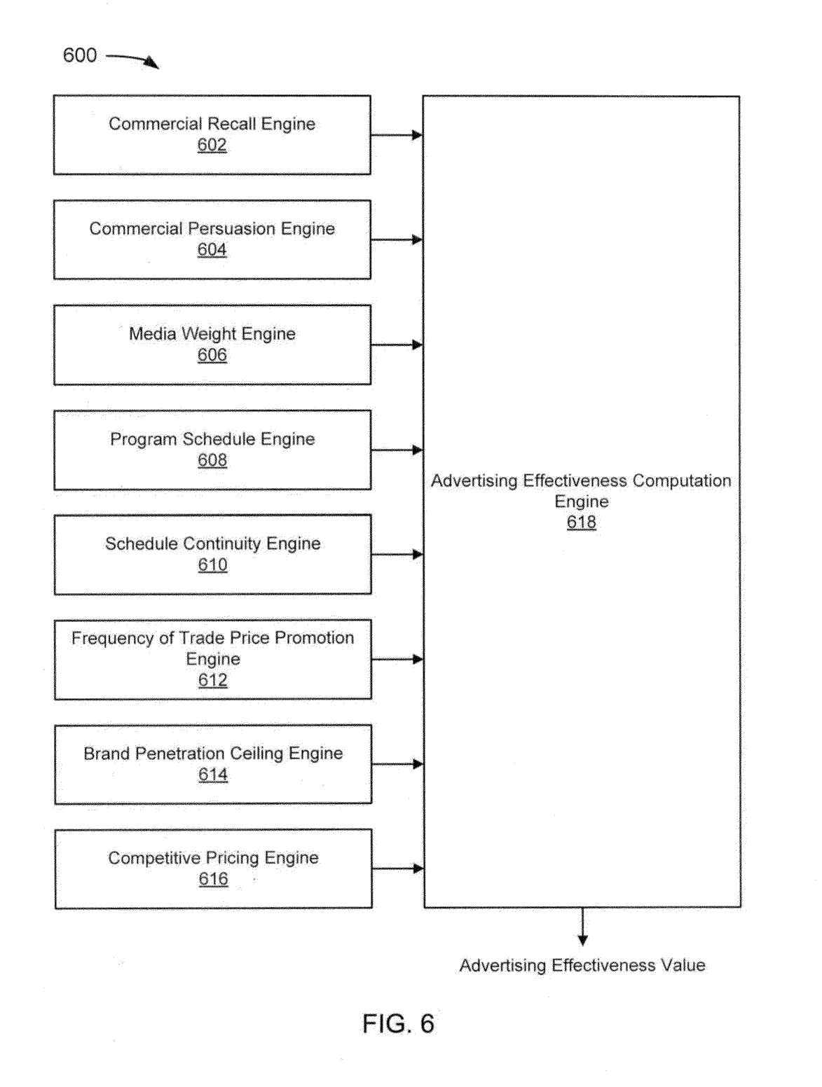

FIG. 6 depicts a diagram 600 of an example of an advertising diagnostics platform. The diagram 600 includes a commercial recall engine 602, a commercial persuasion engine 604, a media weight engine 606, a program schedule engine 608, a schedule continuity engine 610, a frequency of trade price promotion engine 612, a brand penetration ceiling engine 614, a brand pricing relative to competition engine 616, and an advertising effectiveness computation engine 618.

In the example of FIG. 6, the commercial recall engine 602 generates a value associated with the ability of entities associated with SSD to recall a commercial. This concept can be characterized as commercial attention and/or recall. If there is advertising awareness tracking data, a robust spike in advertising awareness is expected when there is an advertising flight airing relative to the levels when advertising is off air. It has been determined that a value associated with better than functionally zero performance for commercial recall is 17% or more day-after recall, which is significantly lower than the :30 commercial norm.

In the example of FIG. 6, the commercial persuasion engine 604 generates a value associated with the ability of entities associated with SSD to have a favorable reaction to a commercial. It has been determined that a value associated with better than functionally zero performance for commercial persuasion is a weekly ad lift greater than a 120. Lower ad lift levels between 115 and 120 can indicate a persuasive commercial if Attention/Linkage, Media Weight and Program Schedule appear to be significantly greater than their critical values.

Commercial recall and commercial persuasion can be characterized as “copy.” In a specific implementation, copy is considered to have the greatest leverage of the values; it does not cost more to air more effective copy. The ability to capture a target market's attention, which leads to greater recall, has fewer fundamental constraints than other value-deterministic factors, and thus presents great opportunity. Improved attention and recall can proportionally increase ad effect and sales volume. Persuasion is also a function of commercial execution factors, but is constrained by fundamental product benefits.

In the example of FIG. 6, the media weight engine 606 generates a value associated with weekly reach for entities associated with SSD. It has been determined that a value associated with better than functionally zero performance for media weight in when weekly reach levels are a 40 to 45 weekly reach points or higher for a product purchased annually on average 3.5 to 4.0 times. The value for weekly reach can be as low as 30 reach points for products purchased significantly more frequently.

In the example of FIG. 6, the program schedule engine 608 generates a value associated with programming into which advertising is inserted. It has been determined that a value associated with better than functionally zero performance for program schedule is having less Network and Cable Primetime and Evening News Shows represent greater than 20% of the weekly airings. The value for Primetime and Evening News airings can be more than 10% of the weekly airings if the weekly reach is significantly higher than 45 weekly reach points.

In the example of FIG. 6, the schedule continuity engine 610 generates a value associated with advertising schedule continuity. It has been determined that a value associated with better than functionally zero performance for schedule continuity 10 or more weeks of continuous airings. For non-seasonal brands (with no weeks having a seasonal index less than 80 for weekly retail sales, where an index of 100 is equal the arithmetic mean week of a given 52 week year) the value to better than functionally zero performance for Schedule Continuity is having 10 or more weeks of continuous airings. As many continuous weeks of advertising should be scheduled as affordable and profitable at the Media Weight and Program Schedule criteria. This continuous schedule should start as early as possible in the year and should be continuous weeks except concurrently during the same weeks when major retail price promotions are scheduled and most expected. If the brand is seasonal, then weeks for advertising are only ones in which weekly brand retail sales index at 80 or higher. For seasonal brands, the continuous advertising schedule should start as early as possible during the seasonal period(s) when the brand retail sales index is at 80 or higher and preference should be given to coverage during the weeks when the seasonal indexes are rising rather than those when the index is falling. Again, the advertising schedule should be continuous weeks except concurrently during the same weeks when major retail price promotions are scheduled and most expected. For seasonal brands, the critical value to better than functionally zero performance is a schedule with more than 30% coverage of the total annual seasonal weeks.

Media weight, program schedule, and schedule continuity can be characterized as “media.” It has been found that :15's have on average 60% recall of :30's but that does not generally translate to consumer purchase behavior; cognitive relationship is not behaviorally validated on sales. With rare exceptions, 9 out of 10 :15's lift sales at marginally effective 100 to 115 levels. GRPs and frequency are not particularly important. An effective weekly reach of >40 to 45 reach points drives effective penetration lift. It is assumed in this paper that advertising increases penetration online in the week it airs. Traditionally, added correlation of sales with ad half-life is mistaken with repeat purchases tracing from previous new ad-induced penetration buyers. Continuity maximizes penetration growth; flighting hiatuses give it away.

In the example of FIG. 6, the frequency of trade price promotion engine 612 generates a value associated with frequency of trade promotion. It has been determined that a value associated with better than functionally zero performance for frequency of trade price promotion is when a brand has less than 6 major trade price promotions in a given year. The value for functionally zero performance can be lower if the brand is promoted with deeper discounts. The critical value trade promotion frequency can be as low as 4 times a year with the deepest discounts that are Buy One Get One Free or Half Price in nature.

In the example of FIG. 6, the brand penetration ceiling engine 614 generates a value associated with a cumulative annual brand penetration ceiling. It has been determined that a value associated with better than functionally zero performance for cumulative annual brand penetration is when the value is less than 40% to 45%. At this level, it is extremely difficult for advertising to be able to achieve a consistently valid effective weekly ad lift index level. As a brand approaches that ceiling, the difficulty of producing an effective ad effect goes up. The value for better than functionally zero performance can be less than 30% penetration level when the category of penetration level is lower than that of typical products.

In the example of FIG. 6, the competitive pricing engine 616 generates a value associated with brand pricing relative to competition. It has been determined that a value associated with better than functionally zero performance for brand pricing relative to competition is when, on an equivalent unit basis, the advertised brand is premium price less than a 120 index versus its direct competitors. Note: private label products are not included in this pricing comparison. The critical value can be as low as a 110 index for more intensely price competitive product categories.

In the example of FIG. 6, the advertising effectiveness computation engine 618 is coupled to each of the eight described engines. The advertising effectiveness computation 618 can be integrated as part of the SSD analysis engine 110 shown in FIG. 1. In a specific implementation, the advertising effectiveness computation engine 618 can include a multiplier that chain multiplies the values received from each of the engines 602-616. It may be noted that, in this specific implementation, if any of the values are 0, the result of the chain multiplication is also 0. The advertising effectiveness computation engine 618 outputs advertising effectiveness data. The advertising effectiveness data can be an advertising effectiveness value, where zero is associated with zero effectiveness, and other positive values are indicative of increasingly effective advertising.

The values generated in the example of FIG. 6 can be characterized as R=XF, where R is marketplace sales results, X is how likely it is that an entity is exposed to advertising (“probability of exposure”), F is how likely it is that such exposure triggers a choice in the entity (“probability of effect”), and:
X=commercial recall*media weight*program schedule*schedule continuity;
F=commercial persuasion*promo schedule*penetration ceiling*premium pricing.

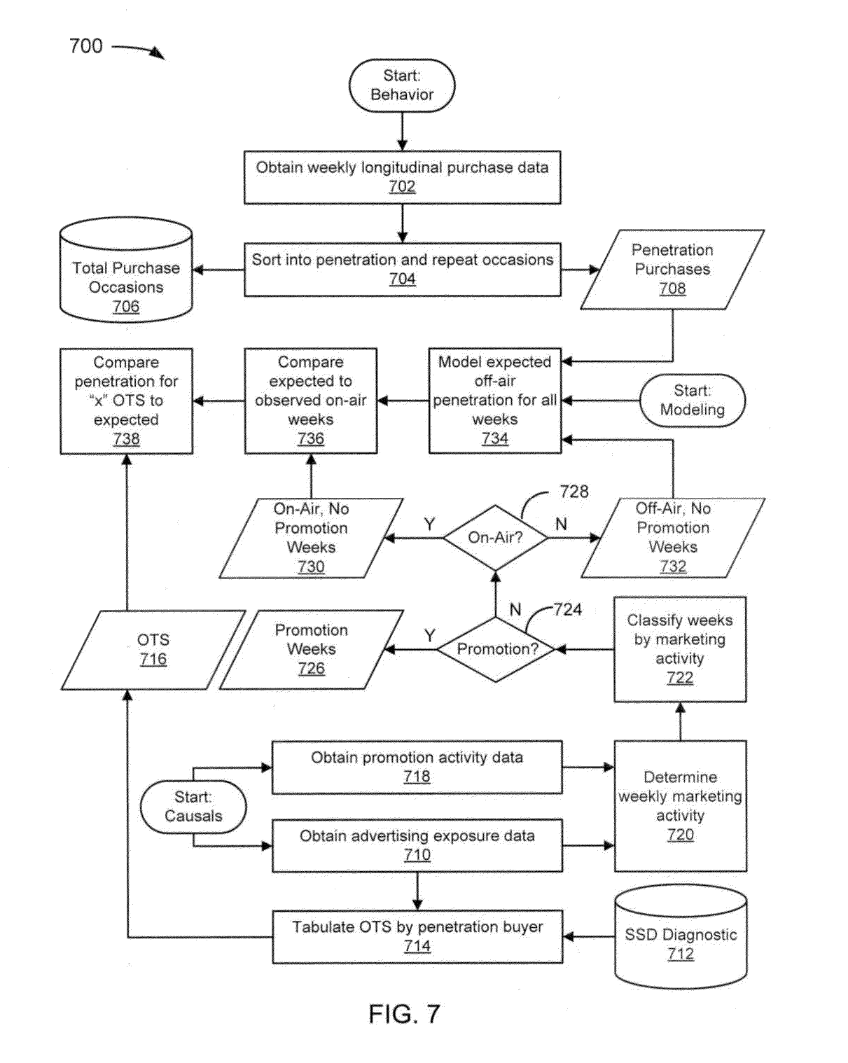

FIG. 7 depicts a conceptual diagram 700 of an example of an SSD analysis flow. The conceptual diagram 700 has multiple starting places and instances of parallel execution. An effort is made to describe them in a relatively serial fashion for ease of understanding. The serial order may or may not be of consequence, depending upon the context.

In the example of FIG. 7, the conceptual diagram 700 starts (for a behavior-capturing portion) at module 702 where weekly longitudinal purchase data is obtained. As has been described previously in this paper, the data can include SSD.

In the example of FIG. 7, the conceptual diagram 700 continues to module 704 where penetration and repeat purchase occasions are sorted. The total purchase occasions (penetration+repeat) can be stored in a total purchase occasions datastore 706. Because the purchase occasions have been sorted, repeat purchase occasions and penetration purchase occasions are determinable within the total purchase occasions datastore 706. For illustrative purposes, penetration purchase occasions 708 are represented as a data module for use later in the conceptual diagram 700 flow.

In the example of FIG. 7, the conceptual diagram 700 starts (for a causals portion) at module 710 where advertising exposure data is obtained. The advertising exposure data and SSD diagnostics from an SSD diagnostic datastore 712 are used to tabulate OTS by a penetration buyer by week. SSD diagnostics can provide values associated with program type, network/cable programming, original/repeat programming, count of OTS, position within pod, time of day, day of week, etc. to aid in establishing an OTS for buyers on a weekly basis. For illustrative purposes, OTS 716 is represented as a data module for use later in the conceptual diagram 700 flow. An advertising and diagnostic data structure model and accumulated learning can be related and applied to single-source measurements and studies. Measured effects among small samples within a small single-source panel can be confirmed in use of an advertising and diagnostic data structure model on a larger panel for purchase behavior predictions.

In the example of FIG. 7, the conceptual diagram 700 starts (for a causal portion) at module 718 where promotion activity data is obtained. It may be noted that the promotion activity data and the advertising exposure data (710) can be obtained in the same data blob, serially, in parallel or in some other applicable manner.

In the example of FIG. 7, the conceptual diagram 700 continues from modules 710 and 718 to module 720 where weekly marketing activity is determined from the advertising exposure data and the promotion activity data.

In the example of FIG. 7, the conceptual diagram 700 continues to module 722 where weeks are classified by marketing activity. At decision point 724, it is determined whether a week has been classified as having a promotion. If it is determined that a week has been classified as a promotion (724-Y), then, for illustrative purposes, the week is part of a promotion weeks 726 data module. If, on the other hand, it is determined that a week has not been classified as a promotion (724-N), then at decision point 728 it is determined whether the week has been classified as an on-air week. If it is determined that the week is an on-air week (728-Y), then, for illustrative purposes, the week is part of on-air, no promotion weeks 730, which is represented as a data module for use later in the conceptual diagram 700 flow. If, on the other hand, it is determined that the week is an off-air week (728-Y), then, for illustrative purposes, the week is part of off-air, no promotion weeks 732, which is represented as a data module for use later in the conceptual diagram 700 flow.

In the example of FIG. 7, the conceptual diagram 700 starts (for a modeling portion) at module 734 where, using the penetration purchases 708 and the off-air, no promotion weeks 732, expected off-air penetration for all weeks is modeled as a data structure. The expected off-air penetration data structure establishes a baseline from which advertising effects on penetration purchasing can be measured.

In the example of FIG. 7, the conceptual diagram 700 continues to module 736 where the modeled expected off-air weeks are compared to observed on-air, no promotion weeks 730. The amount by which the observed is greater than the modeled expected is treated as the advertising effect on purchasing. If the ratio is 1, there is considered to be no advertising effect on purchasing.

In the example of FIG. 7, the conceptual diagram 700 continues to module 738 where penetration for “>x” or penetration for “<x” OTS 716 is compared to modeled expected off-air weeks.

It may be noted that the promotion weeks 726 can also be compared to determine the effect of promotions in a manner that is similar to that just described for advertising effect. Depending upon the context, advertising effect can refer to advertising effect alone or the combination of advertising and promotion effects.

While preferred implementation of the present inventive apparatus and method have been described, it is to be understood that the implementations described are illustrative only and that the scope of the implementations of the present inventive apparatus and method is to be defined solely by the appended claims when accorded a full range of equivalence, many variations and modifications naturally occurring to those of skill in the art from a perusal thereof.

What is claimed is:

1. A method comprising:
obtaining longitudinal single-source data (SSD) over a time interval for a product, the longitudinal SSD having a tight static sample purchase requirement for the time interval;
sorting the SSD into incremental penetration and repeat purchase occasions;
analyzing, by an SSD analysis engine, the incremental penetration and repeat purchase occasions during the time interval;
analyzing incremental marketing activities during the time interval;
generating an advertising effectiveness data structure from an analysis of the incremental penetration and repeat purchase occasions during the time interval and an analysis of the incremental marketing activities during the time interval;
generating an advertising effectiveness report using the advertising effectiveness data structure;
providing the advertising effectiveness report.

2. The method of claim 1, further comprising:
generating an estimate of expected non-promoted penetration and repeat purchase occasions;
generating the advertising effectiveness data structure by comparing the estimate of the expected non-promoted penetration and repeat purchase activity to the analysis of the incremental penetration and repeat purchase occasions during the time interval.

3. The method of claim 2, wherein the advertising effectiveness data structure is generated by comparing only the incremental penetration purchase occasions and the estimate of the expected non-promoted penetration occasions.

4. The method of claim 2, wherein the analysis of the incremental penetration and repeat purchase occasions includes measured sales and the estimate of expected non-promoted penetration and repeat purchase occasions includes a baseline estimate of expected unexposed sales; further wherein, the baseline estimate of expected unexposed sales is compared to the measured sales to generate the advertising effectiveness data structure.

5. The method of claim 1, further comprising:
classifying specific time intervals based on the marketing activities performed during the specific time intervals;
analyzing the incremental penetration and repeat purchase occasions during the specific time intervals;
analyzing incremental marketing activities during the specific time intervals;
generating advertising effectiveness data structure for the specific time intervals from an analysis of the incremental penetration and repeat purchase occasions during the specific time intervals and an analysis of the incremental marketing activities during the specific time intervals.

6. The method of claim 1, wherein analyzing incremental marketing activities during the time interval includes determining a number of times entities associated with the longitudinal SSD are exposed to specific advertising during the time interval and using the number of times the entities associated with the longitudinal SSD are exposed to specific advertising to further generate the advertising effectiveness data structure, the advertising effective data including an amount of exposure to the specific advertising that is necessary to achieve a desired effect on the entities associated with the longitudinal SSD.

7. The method of claim 1, wherein the tight static sample purchase requirement corresponds to an amount of time that is required so that advertising effectiveness data in the generated advertising effectiveness data structure is accurate.

8. The method of claim 1, further comprising:
receiving a value associated with the ability of entities associated with the longitudinal SSD to recall a commercial;
receiving a value associated with the ability of entities associated with the longitudinal SSD to have a favorable reaction to the commercial;
generating the advertising effectiveness data structure based in part on the value associated with the ability of entities associated with the longitudinal SSD to recall a commercial and the value associated with the ability of entities associated with the longitudinal SSD to have a favorable reaction to the commercial.

9. A method comprising:
obtaining longitudinal single-source data (SSD);
sending the longitudinal SSD to an SSD analysis engine configured to disaggregate the longitudinal SSD into incremental penetration and repeat purchase occasions in time intervals, establish a baseline that is treated as functionally equivalent to single-source isolation of sales among entities unexposed to advertising and determine advertising effectiveness data that represents advertising effectiveness from measured sales over the baseline;
receiving, from the SSD analysis system, the advertising effectiveness data.

10. The method of claim 1, wherein the longitudinal SSD has a tight static sample purchase requirement for the time interval.

11. The method of claim 1, wherein the advertising effectiveness data includes a number of times that an entity needs to be exposed to advertising before a desired effect on the entity is achieved.

12. The method of claim 1, wherein the measured sales are determined only from the incremental penetration occasions.

13. A system comprising:
an SSD compilation engine configured to obtain longitudinal single-source data (SSD) over a time interval for a product, the longitudinal SSD having a tight static sample purchase requirement for the time interval;
an SSD analysis engine configured to:
sort the SSD into incremental penetration and repeat purchase occasions;
analyze the incremental penetration and repeat purchase occasions during the time interval;
analyze incremental marketing activities during the time interval;
generate advertising effectiveness data from an analysis of the incremental penetration and repeat purchase occasions during the time interval and an analysis of the incremental marketing activities during the time interval;
a report display engine configured to display an advertising effectiveness report based on the advertising effectiveness data.

14. The system of claim 1, wherein the SSD analysis engine is further configured to:
generate an estimate of expected non-promoted penetration and repeat purchase occasions;
generate the advertising effectiveness data by comparing the estimate of the expected non-promoted penetration and repeat purchase activity to the analysis of the incremental penetration and repeat purchase occasions during the time interval.

15. The system of claim 14, wherein the SSD analysis engine is configured to generate the advertising effectiveness data by comparing only the incremental penetration purchase occasions and the estimate of the expected non-promoted penetration occasions.

16. The system of claim 14, wherein the analysis of the incremental penetration and repeat purchase occasions includes measured sales and the estimate of expected non-promoted penetration and repeat purchase occasions includes a baseline estimate of expected unexposed sales; further wherein, the SSD analysis engine is configured to generate the advertising effectiveness data by comparing the baseline estimate of expected unexposed sales to the measured sales.

17. The system of claim 13, wherein the SSD analysis engine is further configured to:
classify specific time intervals based on the marketing activities performed during the specific time intervals;
analyze the incremental penetration and repeat purchase occasions during the specific time intervals;
analyze incremental marketing activities during the specific time intervals;
generate advertising effectiveness data for the specific time intervals from an analysis of the incremental penetration and repeat purchase occasions during the specific time intervals and an analysis of the incremental marketing activities during the specific time intervals.

18. The system of claim 13, wherein in analyzing incremental marketing activities during the time interval includes, the SSD analysis engine is further configured to determine a number of times entities associated with the longitudinal SSD are exposed to specific advertising during the time interval, and the SSD analysis engine is further configured to use the number of times the entities associated with the longitudinal SSD are exposed to specific advertising to generate, in part, the advertising effectiveness data, the advertising effective data including an amount of exposure to the specific advertising that is necessary to achieve a desired effect on the entities associated with the longitudinal SSD.

19. The system of claim 13, wherein the tight static sample purchase requirement corresponds to an amount of time that is required so that the generated advertising effectiveness data is accurate.

20. The method of claim 13, wherein the SSD analysis engine is further configured to:
receive, from a commercial recall engine, a value associated with the ability of entities associated with the longitudinal SSD to recall a commercial;
receive, from a commercial persuasion engine, a value associated with the ability of entities associated with the longitudinal SSD to have a favorable reaction to the commercial;
generate the advertising effectiveness data based in part on the value associated with the ability of entities associated with the longitudinal SSD to recall a commercial and the value associated with the ability of entities associated with the longitudinal SSD to have a favorable reaction to the commercial.
